(19) United States
(12) Patent Application Publication
(10) Pub. No.: US 2003/0007645 A1
(43) Pub. Date: Jan. 9, 2003

(54) Method and system for allowing a sender to send an encrypted message to a recipient from any data terminal

(75) Inventor: Amiram Ofir, Jerusalem (IL)

Correspondence Address: BROWDY AND NEIMARK, P.L.L.C., 624 NINTH STREET, NW, SUITE 300, WASHINGTON, DC, 20001-5303, US

(73) Assignee: Safe Mail International Limited Ernest & Young Trust Corporation (BVI) Limited

(21) Appl. No.: 09/898,493

(22) Filed: Jul. 5, 2001

(51) Int. Cl. H04L 9/00

(52) U.S. Cl. 380/282

(57) ABSTRACT

A virtual network connectable to a data communications network for allowing a sender to send an encrypted message to at least one recipient from any data terminal connected to the data communications network. The virtual network comprises a respective user space dedicated to the sender and each recipient for storing a respective public and a respective private key thereof, and at least one computer coupled to each user space for controlling access thereto so as to allow the sender and each recipient unrestricted access to his own user space for accessing his own public and private keys while allowing access to the public key only in any other user space.

### FIELD OF THE INVENTION

This invention relates to data encryption using public and private keys.

### BACKGROUND OF THE INVENTION

In a certain sense, the evolution of the computer has come full circle. Before the advent of the micro or “personal” computer, computing power was centralized. Thus, mainframes and later minicomputers concentrated all the processing power remote from their users, who accessed the mainframe or minicomputer via local terminals. At first, the terminal that served as the user interface with the mainframe or minicomputer had no inherent computing power and was termed a “dumb” terminal.

Not only was processing power centralized, but so too was the data, all of which was stored on a remote disk associated with the mainframe or minicomputer. Thus, several remote users all wishing to archive data, actually archived the data on the same disk. Data security was ensured by virtue of the computer allocating different storage areas or partitions to each user and providing remote user access only to authorized users properly identifying themselves to the computer. Moreover, two (or more) users remotely connected to the computer could securely transfer data to each other since, actually, the data need only be copied from the sender's partition to the recipient's partition, without any need for communication of the data to the outside world.

The advent of the personal computer, and in particular the Internet, changed the manner in which data security was handled, since instead of a plurality of remote users communicating via a centralized computer, they now communicated via distributed computers all connected to a common network. The resulting flow of data through the network has effectively rendered all data publicly accessible since it is susceptible to interception en route and, in order to restore privacy, it has become necessary to encrypt the data so that only authorized users are able to make sense of it.

One well-known mechanism for doing this is public key algorithm such as the so-called RSA algorithm developed by Rivest, Shamir, Adleman (RSA) system, as described in Rivest, Shamir and Adleman, “A Method of Obtaining Digital Signatures and Public Key Cryptosystems”, CACM, Vol 21, pp 120-126, February 1978. Reference to this algorithm is given in U.S. Pat. No. 5,557,678 (Ganesan) entitled “System and method for centralized session key distribution, privacy enhanced messaging and information distribution using a split private key public cryptosystem”, which gives a good introduction to the public key encryption algorithm of which RSA is but one example.

There is a growing trend toward using public-private key encryption for communicating over public communication networks, such as the Internet. For so long as the sender himself encrypts the data prior to transmission, this imposes the requirement that each recipient's public key be stored in such a manner as to allow local access by the sender. In order for such a system to be truly portable, the public keys of all potential recipients must be accessible to each sender, in much the same way that a telephone directory must record vast numbers of telephone numbers that will never in practice accessed by a single subscriber, in order to permit access to any required telephone number. This means that well in excess of 100 million public keys must be rendered accessible to each user, even though in practice he is unlikely to access more than several hundred. It is clearly impractical to store these locally on each client machine: both in terms of the disk capacity that would be required and in terms of the maintenance of such storage.

U.S. Pat. No. 6,061,448 to Tumbleweed Communications Corporation entitled “Method and system for dynamic server document encryption” discloses a method and system for secure document delivery over a wide area network, such as the Internet. A sender directs a Delivery Server to retrieve an intended recipient's public key. The Delivery Server dynamically queries a certificate authority and retrieves the public key. The public key is transmitted from the Delivery Server to the sender. The sender encrypts the document using a secret key and then encrypts the secret key using the public key. Both encrypted document and encrypted secret key are uploaded to the Delivery Server, and transmitted to the intended recipient. The intended recipient then uses the private key associated with the public key to decrypt the secret key, and uses the secret key to decrypt the document. In an alternative embodiment of the invention, the sender uses the public key to encrypt the document. In yet another embodiment, the server transmits the document to the Delivery Server for encryption.

This system addresses the problem in acquiring the recipient's public key for encrypting the outgoing message and obviates the need for the respective public keys of all possible recipients to be stored locally on the sender's client machine. However, since the sender himself must then encrypt the outgoing message, this means that either his mail client program must be customized or adapted to perform the necessary encryption; or, alternatively, there must be provided a plug-in module that is compatible with the mail client program. Thus, the approach proposed by Tumbleweed obviates the need for local storage, but at the expense of requiring special processing power in each client machine for encrypting the outgoing message with the recipient's public key. This reduces the flexibility of the system since a user must have access to a computer in which the necessary decryption software is loaded.

More significantly, in order to encrypt data prior to sending it to a specific recipient, the sender's mail client program must know the respective public key of each intended recipient. At the very minimum this requires that some kind of dialog be established with each recipient, at least the first time that encrypted data is sent, in order to ascertain his public key, which may then be stored in the sender's client machine for future use. The dialog can be implemented by automatically sending an e-mail message to the intended recipient requesting receipt of his or her public key. This process is time-consuming and cumbersome, particularly when messages are to be sent securely to large numbers of recipients.

These requirements militate against the increasing trend to allow a user to work from any computer, by providing universal access to the Internet from hotel rooms, airport lounges and the like. Since computers provided at premises remote from the user's place of residence will not be set up to perform the required decryption of data received from the server, a user is either unable to access his data or must equip himself with a portable computer: something which is not always either practical or convenient.

It would therefore be desirable to store the public keys of all intended recipients using public-private key encryption algorithms in such a manner as to allow access by any sender, while not requiring that they be stored centrally. It would be a further advantage to allow an outgoing message to be encrypted with the recipient's public key without requiring customized software in the e-mail client program resident on the sender's client machine.

### SUMMARY OF THE INVENTION

It is therefore an object of the invention to provide a method for allowing a client machine to send to a recipient an outgoing message that is encrypted with the recipient's public key without requiring that the recipient's public key be downloaded to the client machine, and without requiring a customized e-mail client program to be resident on the sender's client machine.

To this end there is provided in accordance with a broad aspect of the invention a method for allowing a sender to send an encrypted message to at least one recipient from any data terminal being capable of sending secure data to a remote server both connected to a data communications network, said method comprising:

(a) providing a virtual network connectable to the data communications network and providing access to a respective user space dedicated to the sender and each recipient for storing a respective public and a respective private key thereof, and

(b) controlling access to each user space so as to allow the sender and each recipient unrestricted access to his own user space while allowing either restricted or no access to any other user space.

In effect, such an approach partitions many users' data on a central medium remote from the users and avoids the need to convey the data to local devices serving respective users. The central medium may, in practice, be distributed so that the public keys of multiple users are stored amongst several servers. In this case, the public key of a specified recipient that is resident in a user space remote from that of the sender may be sent to the recipient's user space. This requires that the public key be conveyed along a public data communications network but it is never required directly by the sender who may thus access his or her own user space via a “dumb” terminal. Such an approach can be combined with known data communication networks (such as the Internet) where local terminals are not dumb, but to the contrary, have advanced processing and data storage capability. In such case, sensitive data should be encrypted prior to transfer between the local terminals and the central repository. It should be noted that, even in the case that they are distributed in such manner, it will be appreciated that all the public keys are managed by a single authority and thus no distinction is made in the description as to whether the “central repository” relates to a single storage medium or to a distributed storage medium.

Central storage of sensitive data allows public keys of all users to be stored on a central repository in a respective partition dedicated to each user or, as noted above, to be distributed among different storage media. This, in turn allows a computer associated with the central repository to encrypt data belonging to a desired user who wants to send data securely prior to onward transfer to one or more desired recipients. This obviates the need for the sender to encrypt the data and thus avoids the need for the sender to work from a smart terminal having local access to the sender's public and private keys and including processing capability for performing the required data encryption.

It will be appreciated that this represents a fundamental shift in network configuration. First, it is now possible for the sender to send and receive data from a comparatively “dumb” terminal having restricted public-private key processing capability. It should be noted that such terminals cannot be entirely “dumb” since secure communication to the user's virtual space is still required and this is typically achieved using SSL, which requires the user's terminal to encrypt secure data with the public key of the server to which data is to be transmitted. Moreover, the user's terminal normally generates a symmetric key, which it then encrypts with the server's public key and the symmetric is then used by the server and the user's terminal in subsequent secure data communication between the two. Likewise, data may be received securely from the server and decrypted by the user's terminal using the symmetric key. In practice, it is most likely that users will use smart terminals such as personal computers. However, the fact still remains that such terminals are not involved in the encryption and decryption of data using the public and private keys of the user; and therefore do not need to store locally the sender's private key and a respective public key for each recipient. This greatly enhances security since theft of the user's computer does not provide access to his private key; and avoids the prior need to access a central authority for downloading therefrom a recipient's public key to the sender's machine.

Whilst it is true that storing data in a central repository is not itself novel, since this is what was done when processing was centralized using mainframes and minicomputers, there was then no data communications network through which the flow of data was publicly accessible. In this context, several factors must be remembered and emphasized. First, the Internet is effectively a public data communications network. There is no predetermined path for routing data from a source destination to a target destination and such data may be, and usually is, deposited en route at different and unpredictable servers, which are publicly accessible. In contrast to this, terminals are connected to mainframes and minicomputers via the telephone line, which though certainly public is not a public data communications network that is in any way comparable to the Internet. Of course, an eavesdropper can monitor a telephone line spanning two locations in the same way that data between a client machine and an Internet server can be monitored. In both cases, secure transmission requires data encryption (such as SSL in the case of Internet transmission). However, data sent along the telephone network (ISTN) is not deposited at publicly accessible nodes en route. This is quite distinct from the Internet where not only is such data deposited, but may also remain there indefinitely, long after it has been received by the recipient and possibly deleted by both the sender and the recipient.

The very raison d'être of the Internet was to facilitate local storage and processing of data in order to reduce the bottleneck at a central mainframe or minicomputer. Thus, to store data belonging to a user and process it remotely at a central location that is commonly owned by all potential users and to which they all have access via the Internet is counter-intuitive. Yet it offers the very real advantages that public keys can be stored remotely without their needing to be forwarded to each sender; and private keys can be stored in a dedicated partition for each user that is accessible by other users. This avoids the need for the private key to be stored locally on the client's machine and enhances system security.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1 and 2 are block diagrams showing a system employing a virtual network according to the invention;

FIG. 3 is a flow diagram showing the principal operating steps carried out by a computer in the virtual network shown in FIGS. 1 and 2;

FIG. 4 is a block diagram showing a data communications network employing the virtual network shown in FIG. 1;

FIG. 5 is a flow diagram showing the principal operating steps carried out by a computer for sending an encrypted message by a sender having a user space in the virtual network to at least one recipient using the data communications network of FIG. 4; and

FIG. 6 is a block diagram showing functionally the computer used in the data communications network of FIG. 4.

### DETAILED DESCRIPTION OF SPECIFIC EMBODIMENTS

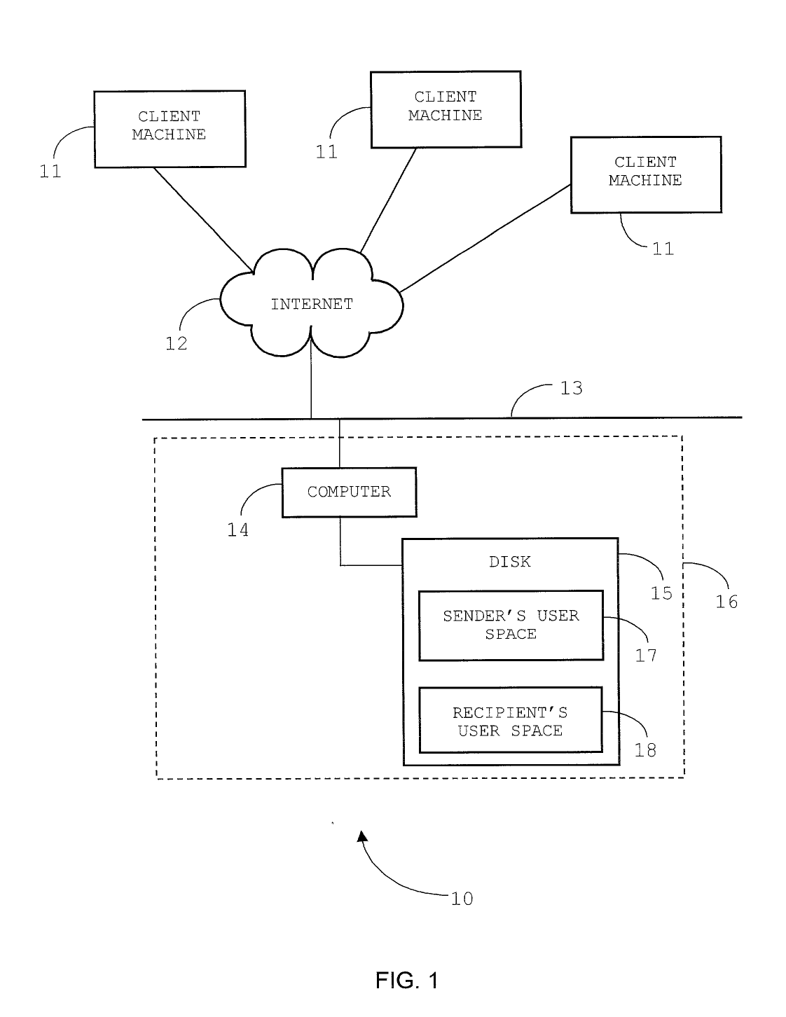

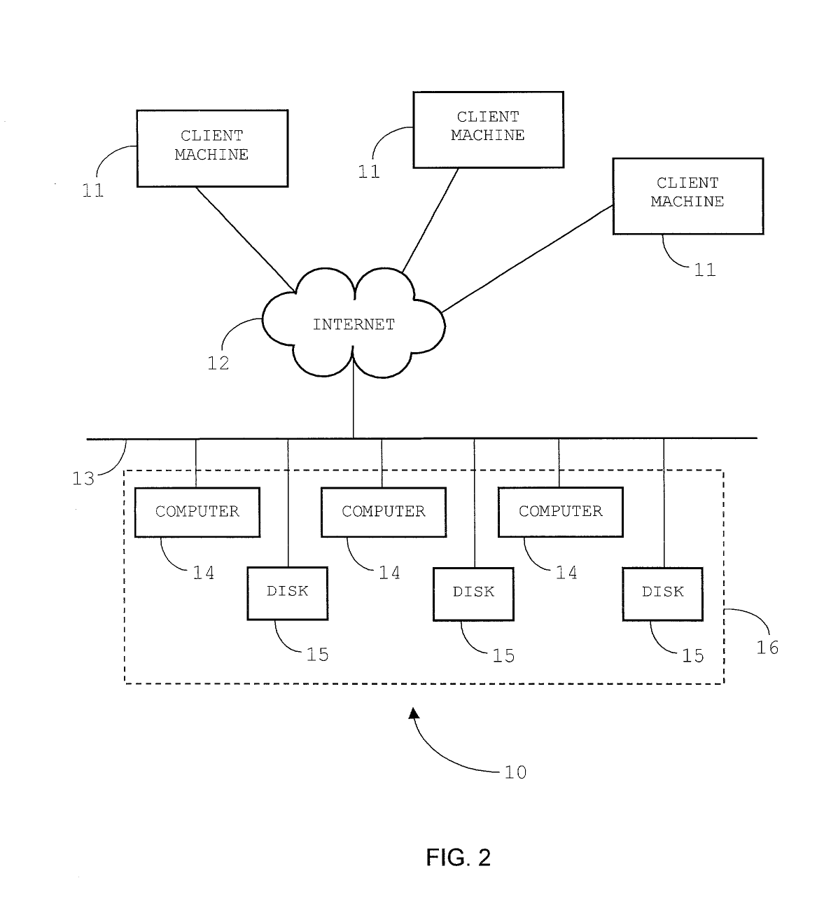

FIGS. 1 and 2 are block diagrams showing functionally a system designated generally as 10 comprising a plurality of client machines 11 coupled via the Internet 12 to a Internet Service Provider (ISP) 13. The ISP 13 comprises a computer 14 coupled to a disk 15, which together constitute a virtual network 16. As shown in FIG. 2, the virtual network 16 can comprises more than one computer 14 and more than one disk 15. In such case, all of the disks may be accessed by any of the computers 14, so that data stored in any of the disks is accessible to each of the computers. Thus, the virtual network 16 is functionally identical in both figures, the multiplicity of computers 14 and disks 15 shown in FIG. 2 merely allowing faster parallel processing and larger disk storage capacity. To this end, in the following description reference will be made to only a single computer 14 and a single disk 15, although it will be understood that, in practice, parallel computers and disks may be employed and these may be geographically separated providing that they are all connected to the ISP 13.

The ISP 13 performs operations on behalf of registered users, each of whom is allocated a respective user space on the disk 15. Each registered user stores data on the disk 15 together with a respective public and private key. The respective public key of each registered user is typically embedded within a certificate. By such means a certification authority may supervise the allocation and maintenance of public and private keys, and may periodically renew a user's authorization to make use of his or her public and private keys by issuing a new certificate attesting to the validity thereof. This allows allocation and period reauthorization of public and private keys, whilst ensuring that a user's public and private keys, once allocated, are never changed unless the user himself suspects that they have been discovered in which case they can be revoked by the certification authority.

In practice, the private key is encrypted so as to increase system security in the event of a hacker accessing the disk 15. This is not a feature of the present invention, but is described in detail together with other enhancements in our co-pending U.S. patent application filed on May 24, 2001, entitled “Method for performing on behalf of a registered user an operation on data stored on a publicly accessible data access server”, Attorney Docket Ofir1, the entire disclosure of which is incorporated herein by reference.

Likewise, the actual operations performed by the ISP 13 on behalf of each registered user are not themselves a feature of the invention but may include any operation that is typically carried out by a web server or by a proxy server on behalf of a client. These include receiving and sending e-mail messages; financial transactions; chat sessions and the like.

Each client machine 11 is typically a personal computer (constituting a data terminal) whose minimum requirements are that it includes a web browser allowing secure communication with the ISP 13. Typically, such secure communication is provided by means of Secure Socket Layer (SSL) allowing the web browser in the client machine to encrypt data prior to transmission to the ISP 13 and to decrypt data received therefrom. However, as will be explained, the client machine 11 does not require access to the user's public or private keys and does not need to encrypt or decrypt data using the user's public or private keys. As a result, the virtual network 16 allows a sender to send an encrypted message to at least one recipient client machine from any data terminal connected to the data communications network, since the data terminal need not be equipped with custom software for public/private key encryption and decryption, as is typically required in hitherto proposed systems.

In the virtual network 16, respective user spaces 17 and 18 on the disk 15 are dedicated to the sender and each recipient for storing a respective public and a respective private key thereof. The user spaces 17 and 18 in respect of the sender and recipient may be on the same disk 15 or, more likely, will be on different disks. However, as noted above, this is immaterial to the operation of the system. Likewise, each computer 14 typically serves more than one user space but it would also be possible for a separate computer to be provided for each user space. The computer 14 is coupled to each user space for controlling access thereto so as to allow the sender and each recipient unrestricted access to his own user space for accessing his own public and private keys while allowing access to the public key only in any other user space. By such means, the sender can access the public key of each intended recipient without being able to access the recipients' private keys.

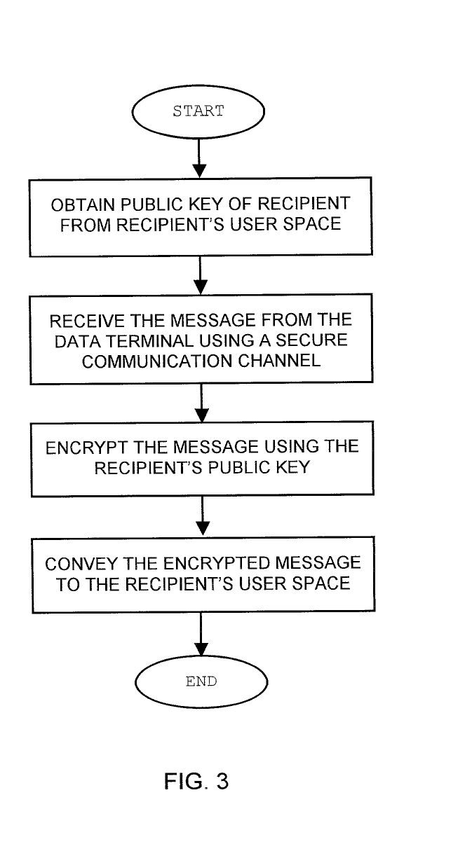

FIG. 3 is a flow chart detailed a method for allowing a sender to send an encrypted message to at least one recipient from a client machine 11 (constituting a data terminal) having a browser capable of sending secure data to a remote server both connected to the Internet 12 (constituting a data communications network). A virtual network 16 is connected to the Internet providing access to a respective user space 17 dedicated to the sender and a respective user space 18 to each recipient for storing a respective public and a respective private key thereof Access to each user space is controlled so as to allow the sender and each recipient unrestricted access to his own user space while allowing either restricted or no access to any other user space. In order to send an encrypted message to the recipient, the computer 14 accesses each recipient's user space 18 to obtain the respective public key of the recipient therefrom, and receives the message from the data terminal constituted by the sender's client machine 11 using a secure communication channel. The computer 14 encrypts the message using the respective public key of each recipient and conveys the encrypted message to the respective user space 18 of each recipient. By such means, each recipient can access the message from any data terminal having a browser capable of receiving secure data from the computer 14 and being connected to the Internet 12.

The message can be encrypted in two ways. One approach is to encrypt the whole message for each recipient with the respective public key so as to generate a different encrypted message for each user. More efficiently, the message is encrypted once only using an intermediate key so as to produce a single message for receipt by all users and to encrypt the intermediate key with the respective public key of each recipient so as to generate a respective encrypted intermediate key for each recipient. The single encrypted message together with at least the respective encrypted intermediate key is then conveyed to the respective user space of each recipient. In practice, a single composite message is sent to all recipients, comprising the single encrypted message and all the encrypted intermediate keys. As an additional security measure, the message can be signed with the sender's private key, thus enabling authentication by the recipient using the sender's public key.

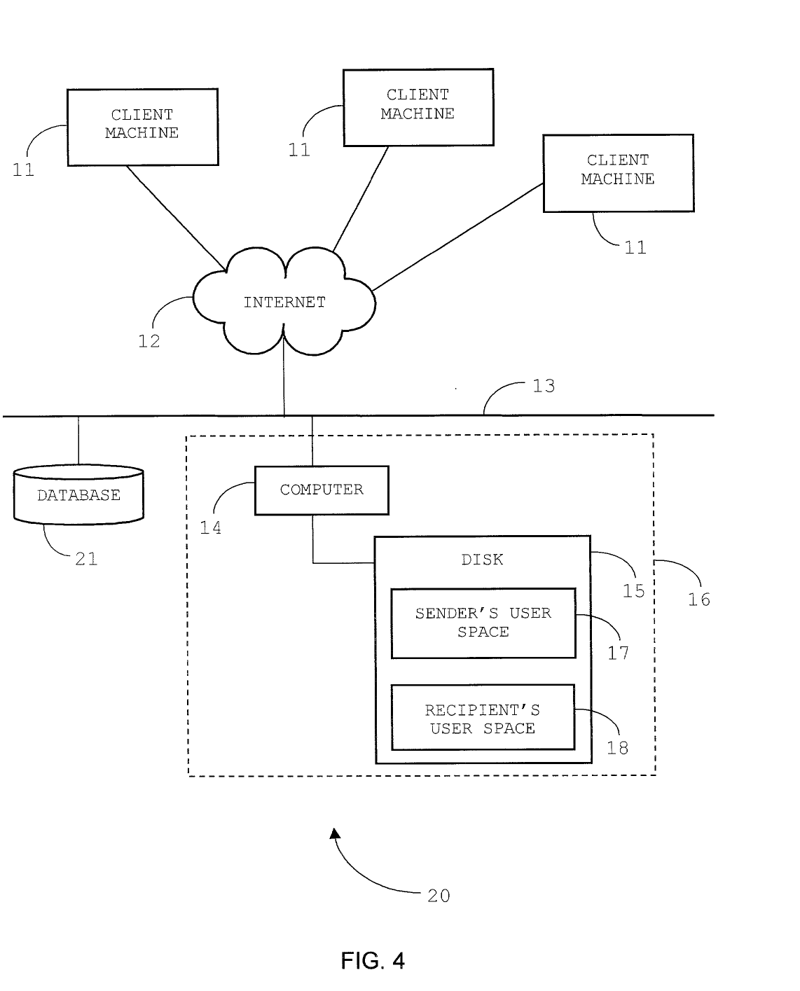

FIG. 4 shows schematically a data communications network 20 based on the system 10 shown in FIGS. 1 and 2 and wherein those components that are common to the system 10 are referenced using identical reference numerals. The data communications network 20 comprises a virtual network 16 allowing a sender to send an encrypted message to at least one recipient from any client machine 11 (constituting a data terminal) connected to virtual network 16 via an Internet Service Provider (ISP) 13. The virtual network comprises a respective user space 17 dedicated to the sender and a respective user space 18 dedicated to each recipient, each for storing a respective public and a respective private key thereof. The virtual network further comprises a computer 14 having access to a disk 15 storing each user space for controlling access thereto so as to allow the sender and each recipient unrestricted access to his own user space for accessing his own public and private keys while allowing access to the public key only in any other user space. It is reiterated that the computer 14 may be, and most typically is, constituted by a plurality of computers having access to multiple disks 15 via the ISP 13. A database 21 is connected to the ISP 13 for storing respective public keys of at least a subset of users not having respective user spaces in the virtual network. Optionally, the database 21 may also serve as a vehicle for storing a copy of the public keys of those users having respective user spaces in the virtual network. This generally provides increased speed, since data access to the database 21 may be faster than to a required node in the virtual network. The database 21 may be stored in one of the disks 15 connected to the ISP 13 or may be maintained by a remote computer (not shown) connected to the Internet 12 and thus accessible to the computer 14.

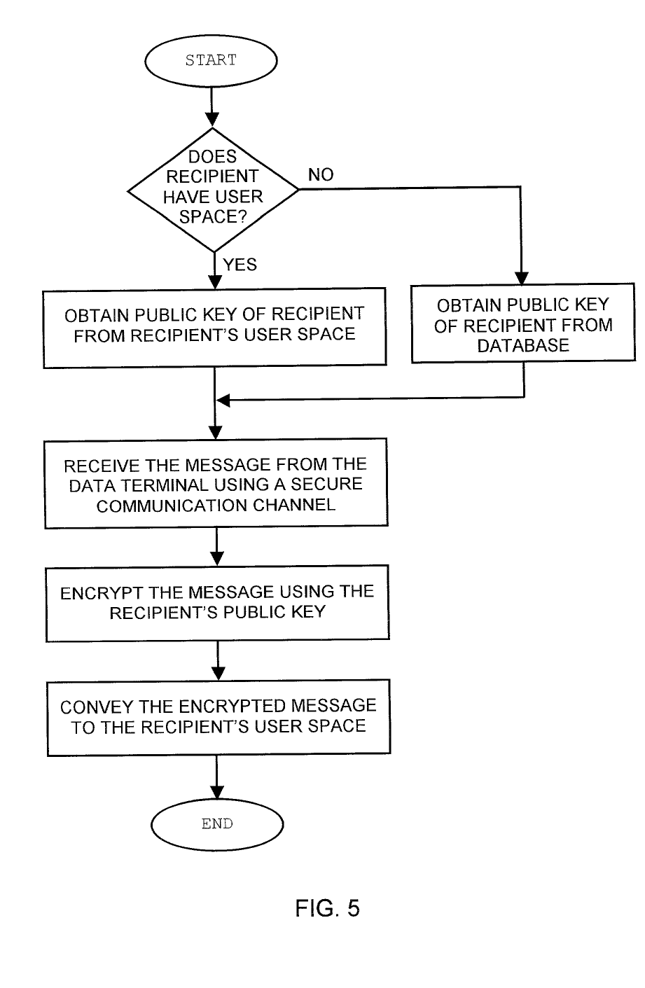

FIG. 5 is a flow diagram showing the principal steps in a method for sending an encrypted message by a sender having a user space 17 in the virtual network 16 to at least one recipient via the data communications network 20. The computer 14 coupled to the sender's user space 17 obtains the respective public key of each recipient having a user space in the virtual network from the respective user space 18 of each recipient. In respect of each recipient not having a user space in the virtual network, the computer 14 obtains the respective public key of the recipient from the database 21. The computer 14 securely receives the message from the data terminal 11 via data communications network 20 and encrypts the message using the respective public key of each recipient.

In the event of a sender having a user space 17 in the virtual network 16, the message received from the data terminal his stored in the sender's user space 17. However, the same method may be employed to send an encrypted message to a recipient having a user space 18 in the virtual network 16 even if the sender does not have a user space in the virtual network 16. In this case, the computer 14 receives the message from the sender's data terminal 11 and stores it on an available area of the disk 15. To this end, the disk 15 can be a disk remote from the virtual network 16 but accessible to the computer 14.

In either case, the message can be encrypted in two ways. One approach is to encrypt the whole message for each recipient with the respective public key so as to generate a different encrypted message for each user. More efficiently, the message is encrypted once only using an intermediate key so as to produce a single message for receipt by all users and to encrypt the intermediate key with the respective public key of each recipient so as to generate a respective encrypted intermediate key for each recipient. The single encrypted message together with at least the respective encrypted intermediate key is then conveyed to the respective user space of each recipient. Thus, in both cases the public key is used to encrypt the message. In practice, a single composite message is sent to all recipients, comprising the single encrypted message and all the encrypted intermediate keys. As an additional security measure, the message can be signed with the sender's private key, thus enabling authentication by the recipient using the sender's public key.

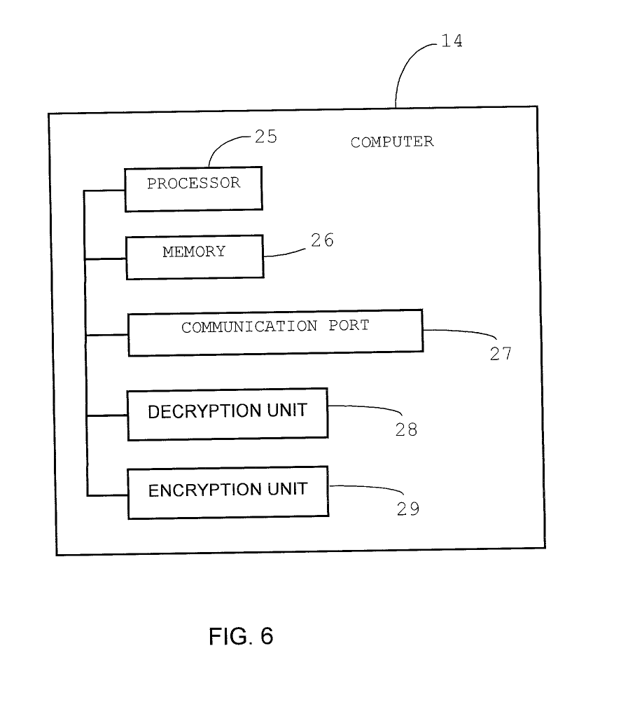

FIG. 6 is a block diagram showing functionally the computer 14, comprising a processor 25 coupled to a memory 26 and a communication port 27 for coupling to the data communications network 20. The computer 14 further includes a decryption unit 28 and an encryption unit 29 both coupled to the processor 25, and typically comprising software modules stored in the memory 26 and executed by the processor 25. As opposed to the computer 14, the client machines 11 shown in FIGS. 1, 2 and 4 do not require decryption and encryption software modules and it is this feature that allows a sender to send a message to a recipient using any data terminal connected to the Internet 12. Likewise, it is this feature that allows any recipient having a user space in the virtual network to receive the message via using any data terminal connected to the Internet 12.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters used to designate claim steps are provided for convenience only and do not imply any particular order of performing the steps.

1. A method for allowing a sender to send an encrypted message to at least one recipient from any data terminal connected to a data communications network and being capable of securely sending data to at least one computer connected to the data communications network, said method comprising:
(a) providing a virtual network connectable to the data communications network and providing access to a respective user space dedicated to the sender and each recipient for storing a respective public and a respective private key thereof, and
(b) controlling access to each user space so as to allow the sender and each recipient unrestricted access to his own user space while allowing either restricted or no access to any other user space.

2. A virtual network connectable to a data communications network for allowing a sender to send an encrypted message to at least one recipient from any data terminal connected to the data communications network, said virtual network comprising:
a respective user space dedicated to the sender and each recipient for storing a respective public and a respective private key thereof, and
at least one computer coupled to each user space for controlling access thereto so as to allow the sender and each recipient unrestricted access to his own user space for accessing his own public and private keys while allowing access to the public key only in any other user space.

3. The virtual network according to claim 2, wherein the at least one computer serves more than one user space.

4. The virtual network according to claim 2, wherein the at least one computer is a separate computer for each user space.

5. The virtual network according to claim 2, wherein the respective public key of the sender and of each recipient is embedded within a certificate.

6. A method for sending an encrypted message by a sender to at least one recipient having a respective user space in the virtual network according to claim 2, the method comprising the following steps carried out by the at least one computer coupled to the sender's user space:
(a) obtaining the respective public key of each recipient from the respective user space of each recipient,
(b) securely receiving the message from the data terminal, and
(c) encrypting the message using the respective public key of each recipient.

7. The method according to claim 6, further including:
(d) conveying the encrypted message to the respective user space of each recipient so as to allow each recipient to access the message from any data terminal capable of securely receiving data from the at least one computer and being connected to the data communications network.

8. The method according to claim 6, further including:
(d) signing the message with the sender's private key.

9. The method according to claim 8, further including:
(e) conveying the encrypted message to the respective user space of each recipient so as to allow each recipient to access the message from any data terminal capable of securely receiving data from the at least one computer and being connected to the data communications network.

10. A data communications network comprising:
a virtual network allowing a sender to send an encrypted message to at least one recipient from any data terminal connected to the data communications network, said virtual network comprising:
a respective user space dedicated to the sender and each recipient for storing a respective public and a respective private key thereof, and
at least one computer coupled to each user space for controlling access thereto so as to allow the sender and each recipient unrestricted access to his own user space for accessing his own public and private keys while allowing access to the public key only in any other user space; and
a database connected to the data communications network for storing respective public keys of at least a subset of users not having respective user spaces in the virtual network.

11. A method for sending an encrypted message by a sender having a user space in the virtual network to at least one recipient via the data communications network according to claim 10, the method comprising the following steps carried out by the at least one computer coupled to the sender's user space:
(a) obtaining the respective public key of each recipient,
(b) securely receiving the message from the data terminal, and
(c) encrypting the message using the respective public key of each recipient.

12. The method according to claim 11, wherein step (a) includes:
i) obtaining the respective public key of each recipient having a user space in the virtual network from the respective user space of each recipient, and
ii) in respect of each recipient not having a user space in the virtual network, obtaining the respective public key of the recipient from the database.

13. The method according to claim 11, Her including:
(d) conveying the encrypted message to the respective user space of each recipient so as to allow each recipient to access the message from any data terminal capable of securely receiving data from the at least one computer and being connected to the data communications network.

14. The method according to claim 11, further including:
(e) signing the message with the sender's private key.

15. The method according to claim 14, further including:
(f) conveying the encrypted message to the respective user space of each recipient so as to allow each recipient to access the message from any data terminal capable of receiving secure data from the at least one computer and being connected to the data communications network.

16. A method for sending an encrypted message by a sender not having a user space in the virtual network to at least one recipient having a user space in the virtual network via the data communications network according to claim 10, the method comprising the following steps carried out by the at least one computer coupled to the at least one recipient's user space:
(a) obtaining the respective public key of each recipient from the respective user space of each recipient,
(b) encrypting the message using the respective public key of each recipient, and
(c) conveying the encrypted message to the respective user space of each recipient so as to allow each recipient to access the message from any data terminal capable of securely receiving data from the at least one computer and being connected to the data communications network.

17. The method according to claim 16, further including:
(d) signing the message with the sender's private key.

18. A program storage device readable by a computer coupled to a respective user space dedicated to a sender and at least one recipient and storing a respective public and a respective private key thereof, said program storage device tangibly embodying a program of instructions executable by the computer to perform method steps for sending an encrypted message by the sender to the at least one recipient, the method comprising the following steps:
(a) obtaining the respective public key of each recipient from the respective user space of each recipient,
(b) receiving the message from a data terminal connected to the machine via a secure communication channel,
(c) encrypting the message using the respective public key of each recipient, and
(d) conveying the encrypted message to the respective user space of each recipient so as to allow each recipient to access the message from any data terminal capable of receiving secure data and being connected to the computer via a data communications network.

19. A computer program product comprising a computer useable medium having computer readable program code embodied therein and being executable by a computer coupled to a respective user space dedicated to a sender and at least one recipient and storing a respective public and a respective private key thereof, the computer program product comprising:
computer readable program code for causing the computer to obtain the respective public key of each recipient from the respective user space of each recipient,
computer readable program code for causing the computer to receive the message from the data terminal via a secure communication channel,
computer readable program code for causing the computer to encrypt the message using the respective public key of each recipient, and
computer readable program code for causing the computer to convey the encrypted message to the respective user space of each recipient so as to allow each recipient to access the message from any data terminal capable of receiving secure data and being connected to the computer via a data communications network.
